(19) United States
(12) Patent Application Publication
(10) Pub. No.: US 2011/0144976 A1
(43) Pub. Date: Jun. 16, 2011

(54) APPLICATION USER INTERFACE SYSTEM AND METHOD

(76) Inventor: ARUN JAIN, Iselin, NJ (US)

(21) Appl. No.: 12/965,542

(22) Filed: Dec. 10, 2010

Related U.S. Application Data
(60) Provisional application No. 61/282,066, filed on Dec. 10, 2009.

(51) Int. Cl. G06F 17/00; G06F 17/27

(52) U.S. Cl. 704/9; 715/226; 704/E11.001

(57) ABSTRACT

The application user interface system and method enables users to give instructions to business software applications by simply entering text in an interface bar in the most intuitive verbal or written human way for carrying out a particular task. The business application, in turn, processes the instruction and presents the summary for review to the users. Upon approval by user, the particular task or request gets executed.

### CROSS-REFERENCE TO RELATED APPLICATION

This application claims the benefit of U.S. Provisional Patent Application Ser. No. 61/282,066, filed Dec. 10, 2009.

### BACKGROUND OF THE INVENTION

1. Field of the Invention

The present invention relates to computer software, and particularly to an application user interface system and method.

2. Description of the Related Art

In Business Software Applications, there are a plethora of menu user interfaces, drop down interfaces, and the like. These interfaces are generally designed as part of the application layer through which humans interact with software applications for giving instructions. The application layer is defined as the OSI (Open Systems Interconnection Reference Model) layer closest to the end user. This means that both the OSI application layer and the user interact directly with the software application.

World over, Computer Application Interfaces are designed to use a navigation tool bar with menu options. Typically, the menu bar, in various forms and shapes, is designed to provide the first set of blocks for various possible tasks that can be performed by the application. With further clicks on any specific block, the User Interface (UI) leads the user to the next screen or drop-down options, or the like. This is traditionally how UIs are designed and implemented.

Among the several shortcomings of current UI design approaches is a long time to complete an activity and a long learning curve for new users. In most cases, it takes several clicks for end-users to reach the desired level at which the activity can be completed. Also, the learning curve for a new user when faced with a new application is long and tends to be similar across applications.

Moreover, there exists a high investment in user training in that it also takes significant amount of user training on various modules of the application before the user can start using the system effectively. This approach becomes very time-consuming, especially in cases where a large number of users need to be trained on a particular application, where the effort can require several hours of training per person-month.

Additionally, there exists a higher design effort required to create a ‘minimum-click’ UI today because at the design level, a significant amount of research has been performed by experts in the GUI field to ensure that the user uses minimum clicks to complete a particular task. Despite this, it takes a long time for GUI interface designers to build application pages with current UI approaches, even after the best possible grouping of various features. The outcome also continues to remain very subjective and person dependent. Furthermore, any new modules added to the application necessitate a redesign of the application menu and drop-downs.

Thus, an application user interface system and method solving the aforementioned problems is desired.

### SUMMARY OF THE INVENTION

The application user interface system and method enables users to give instructions to business software applications by simply entering text in an interface bar in the most intuitive verbal or written human way for carrying out a particular task.

The business application, in turn, processes the instruction and presents the summary for review to the users. Upon approval by user, the particular task or request gets executed.

These and other features of the present invention will become readily apparent upon further review of the following specification and drawings.

### BRIEF DESCRIPTION OF THE DRAWINGS

FIGS. 1A-1B are block diagrams showing process flow of an application user interface system and method according to the present invention.

FIG. 2 is a block diagram showing component connections of an application user interface system according to the present invention.

FIG. 3 is a block diagram showing an exemplary user interface of an application user interface system according to the present invention.

Similar reference characters denote corresponding features consistently throughout the attached drawings.

### DETAILED DESCRIPTION OF THE PREFERRED EMBODIMENTS

The application user interface system enables users to give instructions to business software applications by simply entering text in an interface bar in the most intuitive verbal or written human way (i.e., by natural language) for carrying out a particular task.

The business application, in turn, processes the instruction and presents the summary for review to the users. Upon approval by user, the particular task or request gets executed. The user can give instructions in intuitive human language to the software application. Based on the User Instructions, the user interface software interacts with the business application to locate a relevant form or equivalent object for processing the user instructions.

The form or equivalent object in the business application gets auto-filled based on instructions given by the user. The filled form or equivalent object is presented to the user for verification and submission for processing.

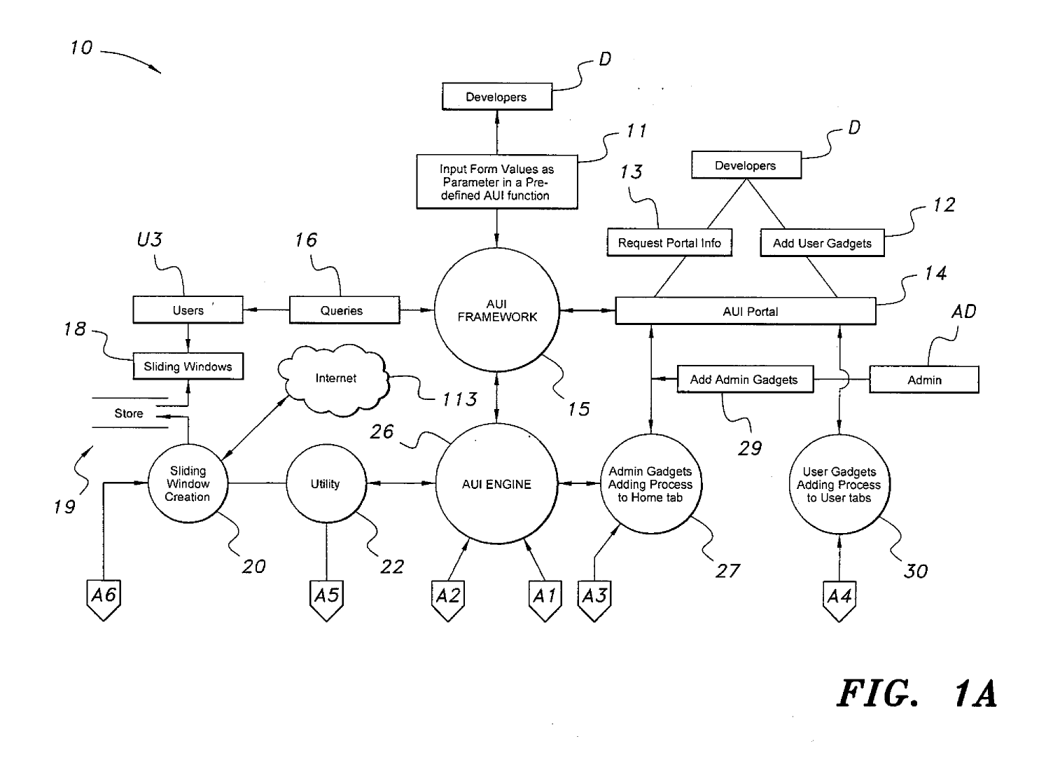

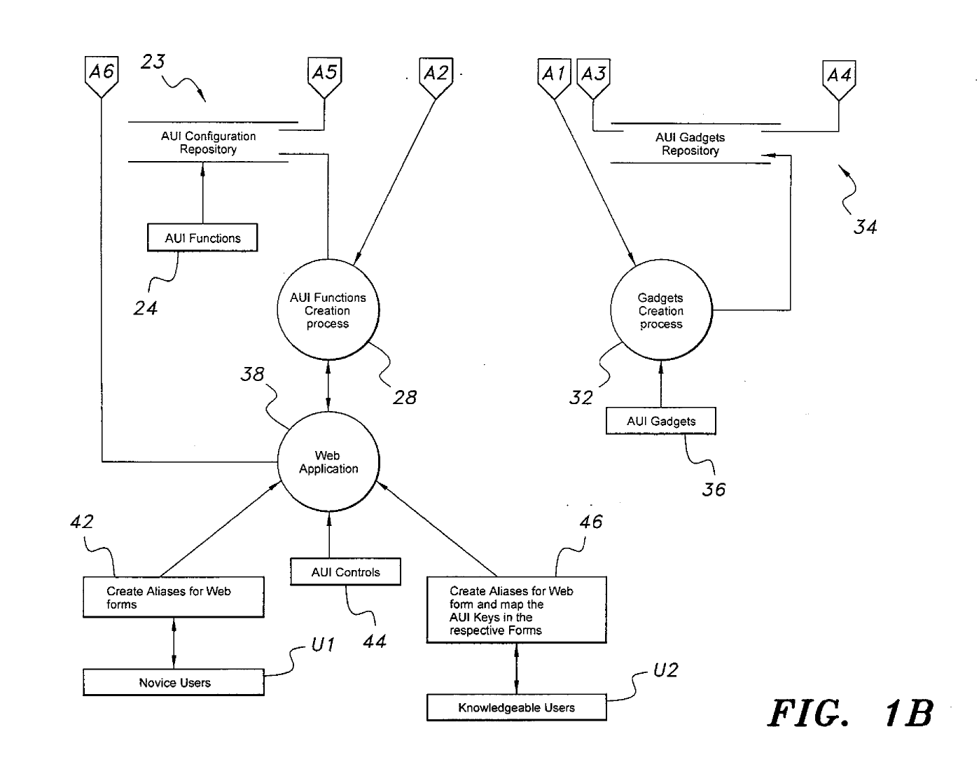

As shown in FIGS. 1A-1B, the developers D are provided with an interface 11 that allows them to input form values as parameters in predefined Application User Interface (AUI) functions. The parameterized AUI functions are made available to the AUI framework 15. The system contemplates the use of gadgets, which are snippets of code that can have persistent storage and multi-user capabilities for achieving forms processing methods. The gadget code snippets are used to control aspects of a system's graphical user interface. The persistent storage allows a portion of forms processing to take place without the gadget being hosted on a user's application server. Instead, the gadget code can be stored in a repository of the system 10 and hosted therein at no memory or processing cost to the user. It is contemplated that the gadgets may be written in XML, and may have HTML and JavaScript components.

In conjunction with the AUI framework 15, developers D can request portal information at step 13 and can add user gadgets at step 12. The AUI portal 14 performs as a gateway between the AUI framework 15 and the developers D, who formulate the requests and add the gadgets. Moreover, an administrator of the system 10 has a gadget-adding interface 29, which connects administrator functions AD to the admin gadgets adding process 27, and also to the AUI framework 15 via the AUI portal 14. The admin gadgets adding process 27 is connected to the AUI gadgets repository 34, from which a user table update process 30 may gain access to updated gadgets that have been added and make them available to users of the system 10.

Standard editing functions are available in the gadget creation process 32 from which AUI gadgets 36 can be created for addition to the AUI gadgets repository 34. The gadget creation process 32 also is connected to the AUI engine 26 for update of AUI functionality based on newly available gadgets. The AUI framework 15 is also connected to the AUI engine 26 and facilitates the passing of information in the AUI functions creation process 28, which is also connected to the AUI engine 26.

Queries from all users U3 are handled by a queries processor 16, which is connected to the AUI framework 15 for handling of the queries by the AUI engine 26. Due to its connection to Internet 113, the sliding window creation process 20 is accessible to all users who have access to the Internet 113. The AUI configuration repository 23 is connected to a sliding window creation utility 22, which updates features available from the sliding window creation process 20. The sliding window creation utility 22 is in operable communication with the AUI engine 26, which manages updates to the AUI configuration repository via the AUI functions creation process 28.

The target web application 38 receives AUI controls 44 and is in operable communication with the AUI functions creation process 28 and the sliding window creation process 20 to support a bifurcated user interface, which connects the system 10 with novice users U1 and knowledgeable users U2. The novice users U1 have access to an aliases creation process 42 for web forms. The knowledgeable users U2 have access to a web forms alias creation and AUI key mapping process 46.

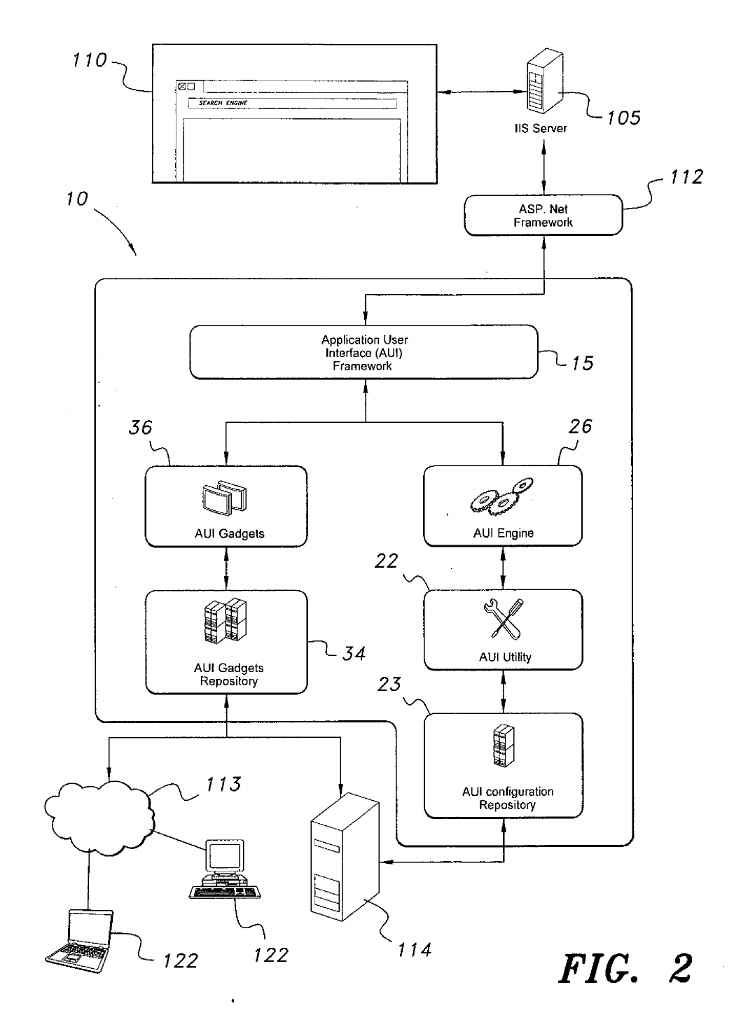

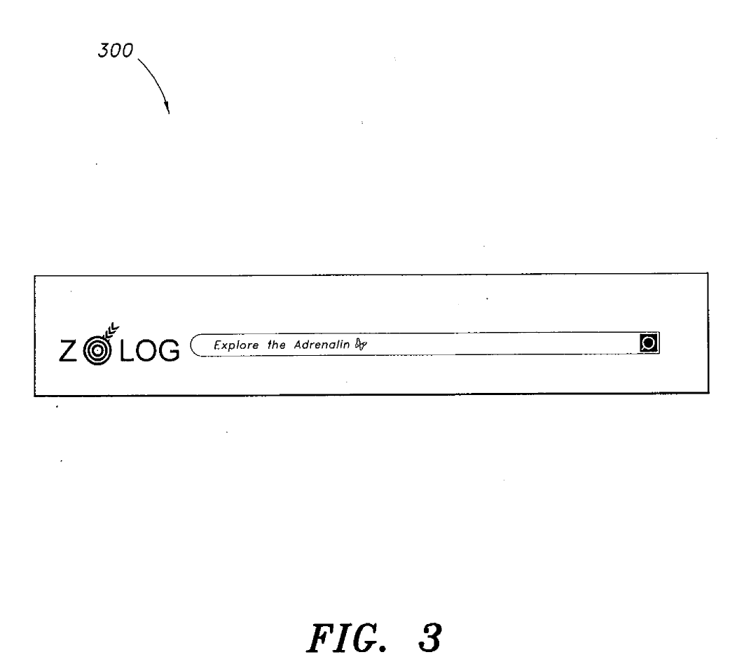

As shown in FIG. 2, the aforementioned system processes have connectivity to an application server 114 and an IIS server 105. User devices 122, being connected to the Internet 113, can query applications using the application user interface 300 via the Internet. The IIS server 105 interfaces with the ASP .net framework 112, which connects to the AUI framework 15. Via the IIS server 105, Internet browsers 110 operated by the users can access the system 10 through ASP .net framework 112.

Exemplary commands that may be entered in the UI bar 300 include, but are not limited to:

Leave Request

I want to apply leave on [Date]/[Day] . . . .

I want leave on [Date]/[Day] . . . .

I want permission to be away from office on [Date]/[Day] . . . .

Please cancel my leave on [Date]/[Day] . . . .

Cancel my travel on [Date]/[Day] . . . .

I want to regularize attendance on . . . .

I wish to resign effective from . . . .

I wish to encash my leave for xxx days . . . .

Reimbursement Requests

I want reimbursement for [purpose] . . . .

Help Requests

I need help on [ ] . . . .

Travel Requests

I wish to travel to on [Date]/[Day] . . . .

I want to travel from [City Name] to [City Name] . . . .

I want to travel from [City Name] to [City Name] on [Date]/[Day] . . . .

I need pick up on [Date]/[Day] . . . .

I need pick up at [City Name] . . . .

Service Requests

I require a laptop . . . .

I wish to officiate . . . .

I need visa for [Country] . . . .

I need salary advance of [Amount] . . . .

I need a salary certificate . . . .

I require business cards . . . .

and,

Training Requests

I wish to attend training on

What are the holidays next month?

Users can enter instructions via the user interface bar 300 instead of using the traditional menus. Moreover, a speech recognition processor may be provided, enabling the users to speak the instructions to an AUI-enabled application. It is contemplated that the system 10 can accept instructions in multiple languages, including, but not limited to, English, Spanish, French, German, Portuguese, Arabic, Urdu, Persian, Hindi, Tamil, Telugu, Kannada, and the like.

The system and method 10 can be applied to various business applications, including, but not limited to, Human Resource Management Software Business Applications, Banking & Financial Software Business Applications, Insurance Software Business Applications, Retail Software Business Applications, Health care Software Business Applications, and the like.

The method can be delivered around various devices, like Web Browsers (Internet Explorer, Netscape, Google Chrome, Mozilla Firefox, etc), Mobile Devices, PDAs & Mini Computers, ATMs & Kiosks.

The method can be applied through any combination of Software & Hardware, e.g., .Net Framework on Windows Platform, Linux, Macintosh Operating Systems, Java Framework on Windows Platform, Linux, Macintosh Operating Systems, Open Systems Software on Windows Platform, Linux, Macintosh Operating Systems.

Searching for Forms in the application (with security authorization) brings the list of likely forms that matches the user search text given in the UI bar.

The system helps the user to transact on a particular form for himself or on behalf of others quickly from the UI Bar rather than navigating multiple menu Items to perform a transaction.

The application user interface system provides a Portal framework that assists users in adding gadgets built by various people on the application user interface Portal space.

The Framework also contains the Quick Launch that facilitates a user to load the frequently used forms or Internet websites with just one click in Sliding window to enable them to refer to and work on multiple information, and thus increases the overall productivity.

It is to be understood that the present invention is not limited to the embodiment described above, but encompasses any and all embodiments within the scope of the following claims.

I claim:

1. A computer-implemented application user interface method, comprising the steps of:
accepting natural language user instructions for input into a business software application;
searching for and retrieving relevant forms and objects from the business software application to process the user instructions;
automatically filling the relevant forms and objects in the business software application based on instructions given by the user;
presenting the filled forms and objects to the user; and
accepting a verification and a request by the user to submit the filled forms and objects to additional business software applications for further processing.

2. The computer-implemented application user interface method according to claim 1, further comprising the step of accepting the natural language instructions as a text entry in an interface bar for carrying out a particular query or task.

3. The computer-implemented application user interface method according to claim 1, wherein said user interface method further comprises the step of providing said user interface method as a service available from the Internet without being hosted on said user's server.

4. The computer-implemented application user interface method according to claim 3, wherein said method further comprises the step of storing and hosting software code utilized by said user interface method in system repositories at no memory-processing cost to said user.

5. The computer-implemented application user interface method according to claim 1, wherein said natural language user instructions accepting step further comprises accepting said user instructions within a browser displayed to said user.

6. The computer-implemented application user interface method according to claim 1, wherein said natural language user instructions accepting step further comprises accepting requests from said user in a natural language subject, natural language verb, and natural language object format following grammatical/syntactical rules of said natural language that expresses a desired service/response from said business application software.

7. The computer-implemented application user interface method according to claim 1, further comprising the step of accepting the natural language instructions into speech recognition software for carrying out a particular query or task.

8. The computer-implemented application user interface method according to claim 1, wherein said natural language accepting step further comprises accepting said natural language instructions in a plurality of languages.

9. The computer-implemented application user interface method according to claim 1, further comprising the step of accepting input form values as parameters in predefined Application User Interface (AUI) functions to aid developer type users in developing said user interface for use by an end user.

10. The computer-implemented application user interface method according to claim 9, wherein said method further comprises providing an AUI framework accepting queries from the end users and from the developer users.

11. The computer-implemented application user interface method according to claim 10, wherein said method further comprises providing an AUI portal accepting portal information requests and entries of user gadget information initiated by the developer users, said AUI portal forwarding the user gadget information for creation of user gadgets, the user gadgets being snippets of code enabling functionality of said user interface.

12. The computer-implemented application user interface method according to claim 11, wherein said AUI framework accepts said user gadget information via operable communication with said AUI portal.

13. The computer-implemented application user interface method according to claim 12, wherein said method further comprises the step of providing an AUI engine, said AUI framework being in operable communication with said AUI engine for creation of said AUI functions and said AUI gadgets, the gadgets being snippets of code providing functionality of said AUI.

14. The computer-implemented application user interface method according to claim 13, wherein said method further comprises the steps of:
accepting aliases for web forms and accepting AUI key maps from a knowledgeable set of users;
accepting only aliases for web forms from a novice set of users; and
providing said web form aliases and key maps to a web application available to the users.

15. The computer-implemented application user interface method according to claim 13, wherein said method further comprises the steps of:
accepting administrative gadget entries from administrative users;
adding administrative functionality to an administrative home page, said administrative functionality being provided by said administrative gadgets.

16. An application user interface system, comprising:
means for accepting natural language user instructions for input into a business software application;
means for locating relevant forms and objects from the business software application to process the user instructions;
means for automatically filling the relevant forms and objects in the business software application based on instructions given by the user;
means for presenting the filled forms and objects to the user; and
means for accepting a verification and a request by the user to submit the filled forms and objects to additional business software applications for further processing.

17. The application user interface system according to claim 16, further comprising means for accepting said natural language user instructions from the user in the form of a natural language subject, natural language verb, and natural language object format following grammatical/syntactical rules of the natural language expressing a desired service/response from said business application software.

18. The application user interface system according to claim 16, further comprising means for providing the system as a software service available from the Internet without being hosted on the user's server.

19. The application user interface system according to claim 16, further comprising:
means for accepting input form values as parameters in predefined Application User Interface (AUI) functions to aid developer type users in developing said user interface for use by an end user;
means for accepting queries from the end users and from the developer users;
means for accepting portal information requests and entries of user gadget information initiated by the developer users;
means for forwarding said user gadget information for creation of said user gadgets, said user gadgets being snippets of code enabling functionality of said user interface;
means for creation of said AUI functions and said AUI gadgets, the gadgets being snippets of code providing functionality of said AUI;
means for accepting aliases for web forms and accepting AUI key maps from a knowledgeable set of said users;
means for accepting only aliases for web forms from a novice set of users;
means for providing said web form aliases and key maps to a web application available to the users;
means for accepting administrative gadget entries from administrative users; and
means for adding administrative functionality to an administrative home page.

20. The application user interface system according to claim 16, further comprising means for creating a sliding window available for requests by the user of said application user interface.
